(19) United States
(12) Patent Application Publication
(10) Pub. No.: US 2011/0205741 A1
(43) Pub. Date: Aug. 25, 2011

(54) LIGHTING EQUIPMENT

(76) Inventor: Norimasa Suzuki, Kanagawa-ken (JP)

(21) Appl. No.: 13/033,398

(22) Filed: Feb. 23, 2011

(30) Foreign Application Priority Data
Feb. 24, 2010 (JP) 2010-039213

(51) Int. Cl. F21V 29/00

(52) U.S. Cl. 362/294; 362/373

(57) ABSTRACT

In one embodiment, a lighting equipment includes a thermally conductive housing. A light source portion formed of a light emitting element as a light source is accommodated in the housing. A spacer element is arranged between an inner wall of the housing and the light source portion to form an accommodation space between the spacer element and the inner wall of the housing. A heat transmitting device thermally connects the light source portion with the inner wall of the housing passing the element accommodation space. The heat generated in the light emitting element is dissipated through the heat transmitting device.

### CROSS-REFERENCE TO RELATED APPLICATION

This application is based upon and claims the benefit of priority from prior Japanese Patent Application No. 2010-039213, filed Feb. 24, 2010, the entire contents of which are incorporated herein by reference.

### FIELD

The present invention relates to a lighting equipment and more particularly a lighting equipment using light emitting devices such LED, as a light source.

### BACKGROUND

In recent years, LED is increasingly used as a light source of the lighting equipment for indoor or outdoor use. Solid light emitting elements, such as LED generates heat during the light emitting operation. Accordingly, the light output falls with the temperature, and its life also becomes short as light emitting elements. For this reason, in the lighting equipment in which solid light emitting elements, such as LED and EL elements are installed as the light source, it is important to suppress the rising of the temperature of the light emitting element in order to improve the characteristic of luminous efficiency and to extend the life.

Moreover, it is necessary to secure space which accommodates an electric power unit for supplying electric power to the light emitting element and controlling the lighting, and a wiring-related component in a case of the lighting equipment. However, the space is influenced by the heat generated in the light emitting element. Therefore, it is in a difficult situation to secure the space efficiently without being influenced by the heat. Conventionally, for example, as shown in Japanese Laid Open Patent Application No, 2007.273209, the heat generated during the lighting operation is conducted to a light source attachment substrate which contacts with the emitting element. Furthermore, the heat is conducted from the light source attachment substrate to the case of the lighting equipment to dissipate the heat.

However, in the technology shown in the above-mentioned Japanese Laid Open Patent Application, the heat generated in the LED light source is conducted to a main portion of the lighting equipment indirectly through the light source attachment substrate. Moreover, the LED light source is not accommodated in the case of the lighting equipment. Furthermore, the application does not disclose at all about the point that the space to secure the electric power unit and the wiring-related component is efficiently obtained.

### BRIEF DESCRIPTION OF THE DRAWINGS

The accompanying drawings, which are incorporated in and constitute a portion of the specification, illustrate embodiments of the invention, and together with the general description given above and the detailed description of the embodiments given below, serve to explain the principles of the invention.

FIG. 1 is a perspective diagram showing a lighting equipment according to an embodiment of the present invention.

FIG. 2 is a perspective diagram showing the lighting equipment shown in FIG. 1 by exploding.

FIG. 3 is a plan view showing a front cover in the lighting equipment shown in FIG. 1 by removing a front cover.

FIG. 4 is a cross-sectional view showing the lighting equipment taken along line X-X in FIG. 3.

FIG. 5 is a perspective diagram showing a light source unit used in the lighting equipment shown in FIG. 1.

FIG. 6 is a perspective diagram showing the light source unit by exploding and looking from the back side.

FIG. 7 is a cross-sectional view showing the light source unit taken along line Y-Y in FIG. 3.

FIG. 8 is a perspective diagram showing an example which combines the light source units.

FIG. 9 is a side view showing an example which combines the light source units.

### DETAILED DESCRIPTION OF THE INVENTION

A lighting equipment according to an exemplary embodiment of the present invention will now be described with reference to the accompanying drawings wherein the same or like reference numerals designate the same corresponding portions throughout the several views.

According to one embodiment, a lighting equipment includes: a thermally conductive housing; a light source portion accommodated in the housing and including a light emitting element as a light source; a spacer element arranged between an inner wall of the housing and the light source portion to form an element accommodation space between the spacer element and the inner wall of the housing; and a heat transmitting device to thermally connect the light source portion and the inner wall of the housing passing the element accommodation space.

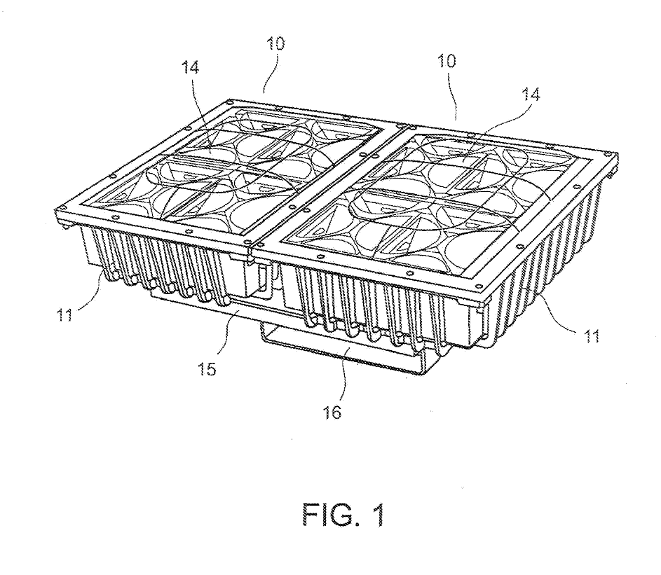

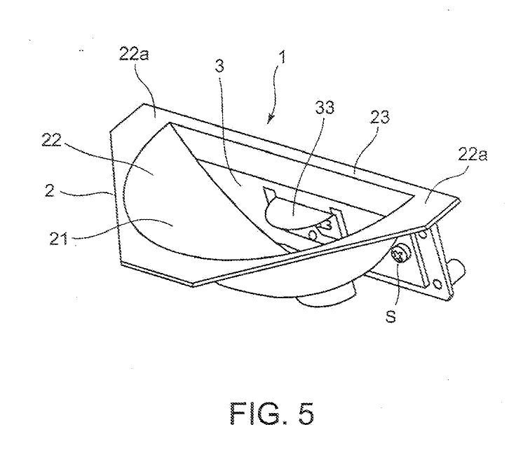

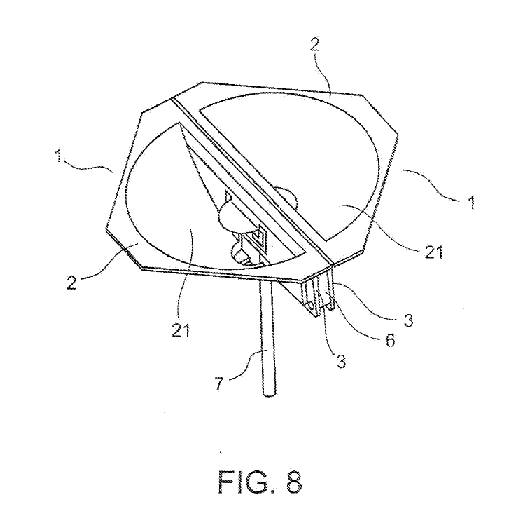

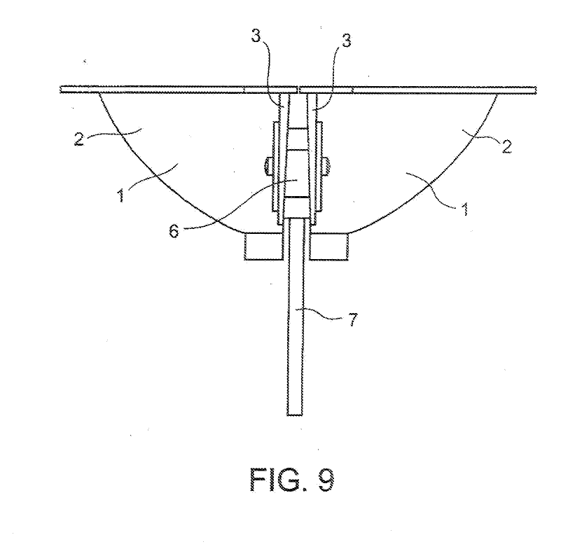

Hereafter, one embodiment of the present invention is explained with reference to Figures. FIG. 1 to FIG. 4 shows a projector suitable for performing lighting which directs night view as a lighting equipment. FIG. 5 to FIG. 9 shows a light source unit equipped in the lighting equipment.

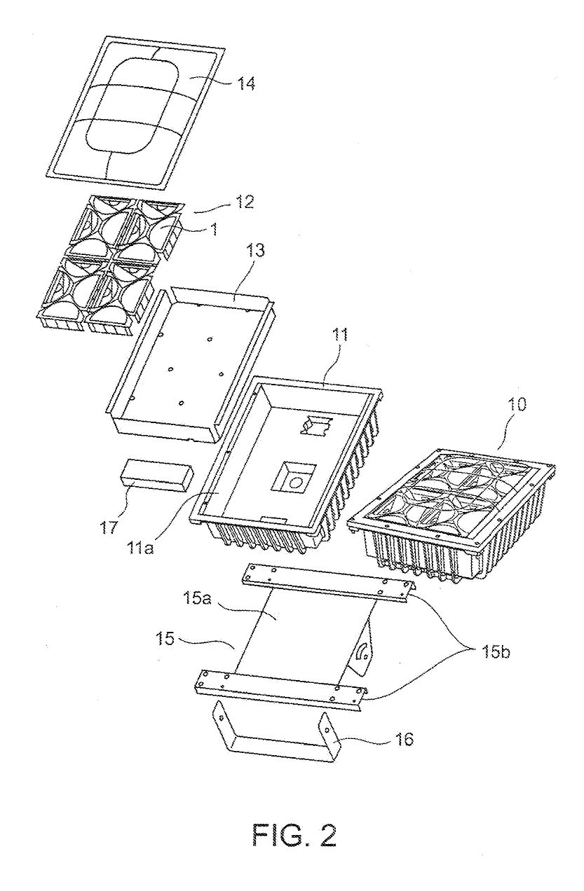

FIG. 1 to FIG. 3 shows a lighting equipment composed of two projectors 10 arranged together. FIG. 2 shows one projector 10 of the two projectors 10 by exploding. The projector 10 includes a housing 11 in a box-like case as a main body, a light source portion 12, a spacer element 13 arranged between the housing 11 and the light source portion 12, and a transmissive front cover 14.

The housing 11 is formed by die-casting of the material with good heat conductivity, such as aluminum alloy. The housing 11 includes an opening 11a in the front side and a plurality of radiation fins provided in the peripheral wall. In the housing 11, a spacer element 13 in the box-shape is accommodated and fixed. The depth size of the spacer element 13 is smaller than that of the housing 11. The spacer element 13 is formed of materials, such as aluminum as well as the housing 11.

The light source portion 12 is formed of a plurality of light source units 1 arranged together which will be explained later, and specifically 16 light source units 1 are arranged together. The light source portion 12 is attached to the bottom wall of the spacer element 13 with a screw, and is accommodated in the housing 11. A power supply unit to supply electric power to the light source portion 12 is fixed at the back side of the spacer element 13

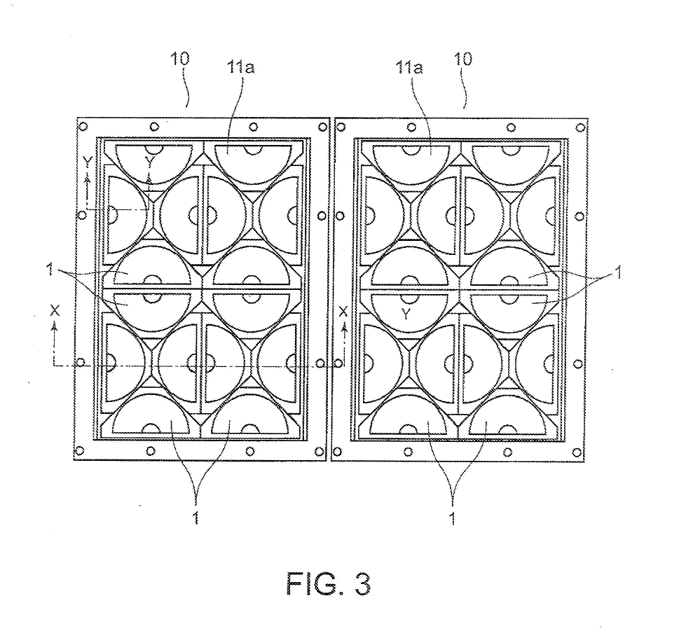

As shown in FIG. 3, each of the light source units 1 is formed in a shape in which an angle part of the right triangle is cut away seeing from the upper surface side. The light source units are efficiently arranged so that the whole irradiation area may become large in the limited area in which the plurality of light source units are arranged together.

The opening of the housing 11 is equipped with a transmissive front cover 14 through a packing. The outer circumference of the front cover 14 is held by a decorated frame, and the front cover 14 expands to the front side. The front cover 14 is formed of polycarbonate or glass material.

The two projectors 10 configured in this way are fixed to a fixture 15. The fixture 15 is composed of a base board 15a and support elements 15b provided in the both sides of the base board 15a. The projector 10 is fixed to the support element 15b by fastener means, such as a screw. Moreover, attachment elements for attaching an angled saddle like arm 16 are respectively formed at the both sides of the base board 15a so as to extend to the back side of the base board 15a, and the arm 16 is attached to the attachment element. According to the structure, the housing 11 is rotatably supported by the arm 16 so that an elevation angle can be adjusted to the light radiation direction.

Moreover, a power supply wire is drawn from the bottom side of the housing 11 through a cable ground which is not illustrated. The power supply wire connects between the light source portion 12 and an electric power supply unit 17 in order to supply electric power to the light source portion 12.

First, the projector 10 configured in this way is fixed to a construction through the arm 16. The radiation direction is adjusted to an object by the arm 16, and then projector 10 is used by supplying power. Thereby, the light emitted from the light source portion 12 penetrates the front cover 14 and is irradiated to the object.

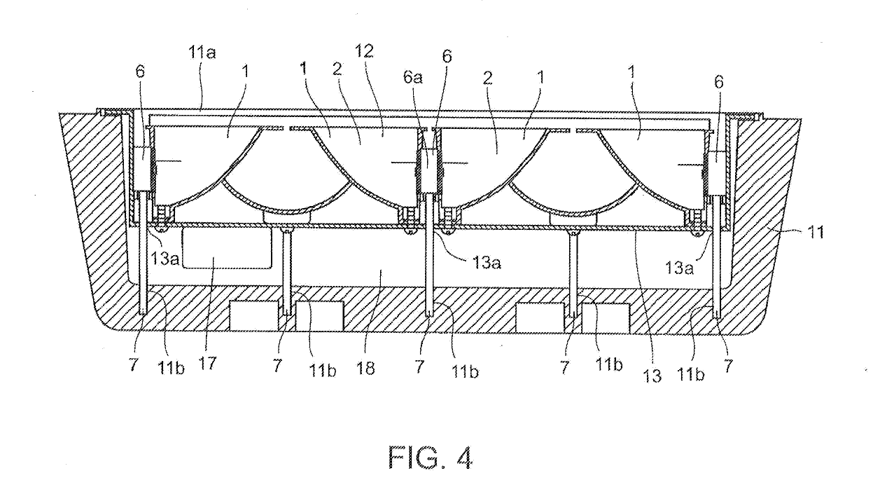

Next, the structure of the housing 11 is explained referring to FIG. 4. The inner circumference wall of the housing 11 is formed in the shape of a box. The spacer element 13 is accommodated and fixed by a screw in the housing 11 so that the perimeter edge of the spacer element 13 is laid in the edge of an opening 11a of the housing 11. The light source portion 12 is attached to a bottom wall of the spacer element 13. The spacer element 13 also functions to support a plurality of light source units 1. Furthermore, the plurality of light source units 1 are attached to the spacer element 13 by the screw clamp etc. from the back side.

The spacer element 13 has a depth size smaller than the inner circumference wall of the housing 11, as mentioned-above. Therefore, the spacer element 13 forms an element accommodation space 18 between the inner circumference wall of the bottom wall of the housing 11 and the light source portion 12. The electric power supply unit 17 is accommodated in the element accommodation space 18 so that the electric power supply unit 17 is attached to the back side of the spacer element 13. Moreover, a wiring-related component, such as a lead which is not illustrated, is arranged in the element accommodation space 18.

Moreover, although the heat receiving element 6 with good heat conductivity, such as aluminum, is arranged at one side of each light source unit 1 which will be explained later for details. A heat pipe 7 in the shape of a nod is provided between the heat receiving element 6 and the bottom wall of the housing 11 as heat transfer means. The heat pipe 7 is fitted to a fitting hole 6a formed in the heat receiving element 6 and a fitting hole 11b formed in the bottom wall of the housing 11, and specifically contacts with the fitting holes 6a and 11b thermally.

Therefore, the heat from the heat pipe 7 is transmitted to the fitting hole 11b side of the bottom wall of the housing 11 from the fitting hole 6a side of the heat receiving element 6 passing a penetration hole 13a formed in the spacer element 13 and the element accommodation space 18. In addition, although it is preferable that the heat pipe 7 is attached to the fitting hole lib of the housing 11 without contacting with the spacer element 13, the heat pipe 7 may contact with the spacer element 13.

An operating fluid is enclosed in the heat pipe 7. The heat pipe 7 conveys heat in a phase cycle of evaporation and condensation of the operating fluid. The operating fluid warmed by the high temperature side evaporates, and moves to the low temperature side to be condensed. The condensed operating fluid returns to the high temperature side by capillary tube action. The heat can be transmitted to the low temperature side from the high temperature side in this cycle.

In addition, although the heat pipe is suitable as heat conduction means from a viewpoint of efficiency, the heat transfer means is not limited to the heat pipe. For example, aluminium alloy material etc. with high thermal conductivity may be used.

Next, the light source unit 1 is explained referring to FIG. 5 to FIG. 9. The light source unit 1 is equipped with a reflector 2, a substrate attachment element 3, a substrate 4, and a light emitting element 5 mounted on the substrate 4.

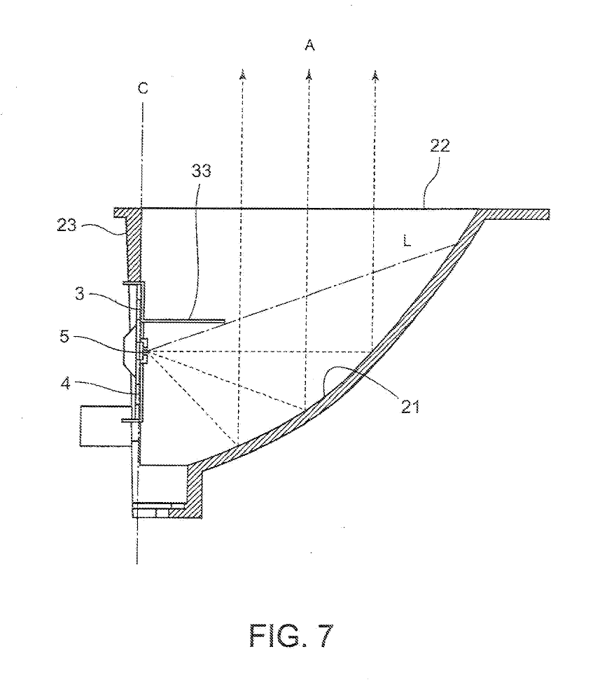

The reflector 2 is formed with synthetic resin materials, such as PBT (poly butylene terephthalate) and has a reflective surface 21 to which aluminum vapor deposition is carried out. The reflective surface 21 includes an irradiation opening 22 and is formed of a portion of a curved surface expanding toward the irradiation opening 22. That is, the reflective surface 21 is configured in the shape of a paraboloid of revolution, which is formed by half-rotating the parabola, for example. Therefore, when it is seen from the upper surface side, the outside shape of the irradiation opening 22 is semi-circle-like. A reinforcing element 23 is formed along a straight line portion of the semi-circle, i.e., between two ends 22a of the irradiation opening 22 where the reflective surface 21 expands most. The reinforcing portion 23 is formed so as to bridge the two ends 22a of the irradiation opening 22. The reinforcing portion 23 is formed in the shape of L character in cross-section as shown in FIG. 7. The reinforcing portion 23 has a function which suppresses deform of the reflective surface 21 formed with synthetic resin material.

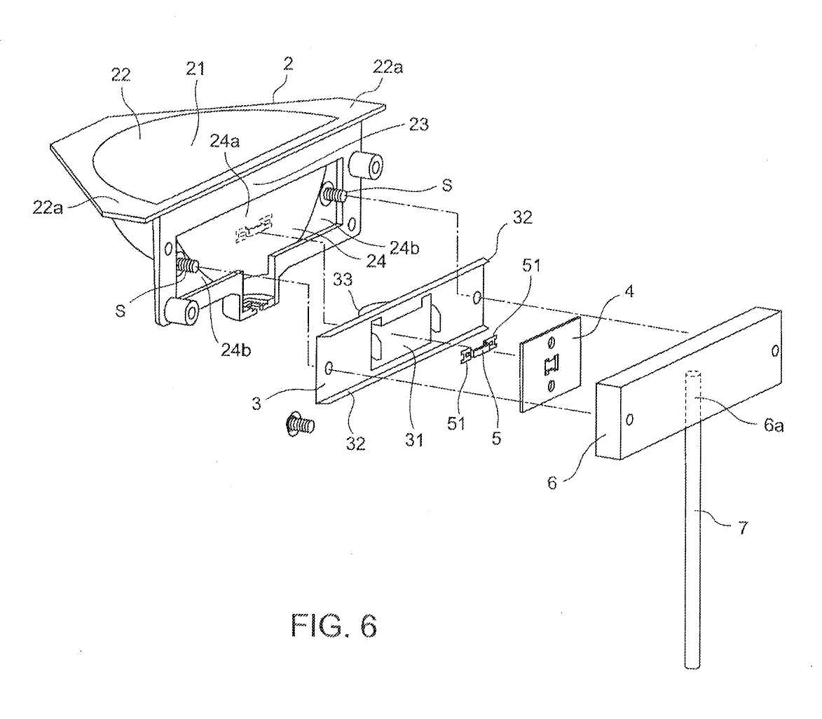

Moreover, as shown in FIG. 5 and FIG. 6, an opening window 24 is formed at a side facing the reflective surface 21. The opening window 24 is formed in the shape of an approximately rectangle, but an opening portion 24a is formed in the shape of an approximately bowl according to the side form of the reflective surface 21. On the other hand, fitting portions 24b for the substrate attachment element 3 are formed in the both sides of the short end sides of the rectangular opening window 24. Screw penetration holes in which the attachment screw S penetrates from the front side are formed in the fitting portions 24b as fastener means. As stated above, the opening window 24 is formed in the down side of the reinforcing element 23 in the figure.

The substrate attachment element 3 is formed of thermally conductive metal, such as aluminum, in the shape of an approximately rectangle as well as the opening window 24 so that the opening window 24 of the substrate attachment element 3 may fit to the inner circumference side of the opening window 24. An opening 31 where the substrate 4 is arranged is formed in the central portion of the substrate attachment element 3, and a pair of guide pieces 32 are formed in the up-and-down long sides of the substrate attachment element 3 by bending long edge portions. By such composition, since the substrate attachment element 3 is guided and positioned by the opening window 24, it becomes easy to arrange the light emitting element 5 to the focal point of the reflective surface 21. Furthermore, as shown in FIG. 5 and FIG. 6, a shielding element 33 is integrally formed by bending an upper portion of the substrate attachment element 3 toward the reflective surface 21 with approximately right angle from the opening 31 of the substrate attachment element 3. The shielding element 33 is formed in the semi-circle in plane so that the semi-circle is arranged in a concentric pattern with the semi-circle formed by the irradiation opening 22 of the reflective surface 21. Therefore, the construction achieves the advantage that the adjustment for shielding the leaked light can be done easily.

The substrate 4 to mount the light emitting element 5 is formed of an insulating rectangular plate, such as glass epoxy resin plate, and a circuit pattern formed of copper foil is provided to its surface side. In addition, when using insulation material as the material for the substrate 4, ceramic material or synthetic resin material with comparatively good heat dissipation characteristic and good characteristic in durability can be used. Moreover, a metal base board formed of metal, such as aluminum with high thermal conductivity and good heat dissipation characteristics can be also used by laminating an insulating layer on the whole surface of the metal base board.

The light emitting element 5 is mounted in the surface side of the substrate 4 through a holder 51 as a light source. The light emitting element 5 is a surface mount type LED package, and is composed of a LED chip arranged in the main surface of the substrate formed with ceramics, and transmissive resin for molding the LED chip, such as epoxy system resin and silicone resin to seal the LED chip. The LED chip is a blue LED chip which emits blue light. The transmissive resin for molding the LED chip contains phosphor which absorbs the emitted light from the LED chip and generates yellow light. Accordingly, the emitted light from the LED chip is emitted outside by being converted into white system color, such as white and electric bulb colors through the transmissive resin of the LED package. In addition, the LED chip may be directly mounted on the substrate 4. Therefore, the mounting method is not limited specifically. Furthermore, it is also possible to equip a light emitting element in a socket etc. and fix the socket to the substrate attachment element 3.

In this embodiment, although solid light emitting elements, such as LED and organic electroluminescence, etc. are used as the light source, for example, the light source is not limited to above light emitting elements.

Thus, the substrate 4 equipped with the light emitting element 5 is attached to the substrate attachment element 3 corresponding to the opening 31. Moreover, the substrate attachment element 3 to which the substrate 4 is attached is positioned by the opening window 24 of the reflector 2 and is attached to the fitting portion 24b. In this case, the outside shape of the substrate attachment element 3 is formed so that the substrate attachment element 3 may fit to the inner circumference side of the opening window 24. The guide pieces 32 of the substrate attachment element 3 are guided to the opening window 24, and further, the substrate attachment element 3 is positioned and arranged so that the front side of the substrate attachment element 3 may contact with the fitting portion 24b of the opening window 24. Then, the substrate attachment element 3 is fixed to the fitting portion 24b from the front side with an attachment screw S. Therefore, the substrate attachment element 3 can be easily arranged with sufficient accuracy in the position decided beforehand. Furthermore, it becomes possible to arrange the light emitting element 5 with sufficient accuracy to the focal point of the reflective surface 21 which will be mentioned later.

In the light source unit 1 shown in FIG. 7, the reflective surface 21 is formed in the form of the paraboloid of revolution by half-rotating the parabola with respect to the principal axis C by the side of the reflective surface 21. The light emitting element 5 on the substrate 4 attached to the substrate attachment element 3 counters the reflective surface 21 so that the light emitting element 5 may be surrounded by the reflective surface 21, and the light emitting element 5 is arranged at the focal point of the parabola of the reflective surface 21. Furthermore, the shielding element 33 is arranged so that the extended line L which connects the chip portion with the light emitting element 5 may be located slightly below from the opening end of the irradiation opening 22. Therefore, the shielding element 33 hardly interrupts the effective light “A” reflected by the reflective surface 21.

As shown in FIG. 6, the heat receiving element 6 and the heat pipe thermally connected with the heat receiving element 6 are arranged at one side of the light source unit 1. The heat receiving element 6 is formed in the shape of rectangular solid and tightly attached to the substrate 4 equipped with the light emitting elements. A fitting hole 6a is formed in the central portion with reference to the long side of the rectangular solid of the heat receiving element 6, and the heat pipe 7 is fitted to the fitting hole 6a.

Basically, the heat pipe 7 is arranged to each light source unit 1. However, in this embodiment, one common heat pipe 7 is provided to two light source units 1 together which are arranged so that the back sides of the respective light source units 1 may face each other. That is, the heat receiving element 6 is sandwiched by both back sides of the light source units 1. Therefore, the common heat receiving element 6 serves the heat receiving function of the two light source units 1, that is, one heat pipe 7 performs the heat transfer of the two light source units 1. Thus, the lighting equipment is configured so that one heat pipe 7 may make the heat transfer of two or more light source units 1 commonly.

Next, the operation of this embodiment is explained with reference to FIG. 7. If power supply is switched on, and electricity is supplied to the light emitting element 5 through the substrate 4, the light emitting element 5 emits light. The emitted light is mainly reflected by the reflective surface 21 and irradiated toward the direction “A” of the irradiation opening 22. Here, since the light emitting element 5 is arranged at the focal point of the reflective surface 21, the light going toward the irradiation opening 22 is irradiated as parallel light without enlarging the beam spreading and being diffused. Therefore, it becomes possible to irradiate with the light efficiently by directing spotlight an object. Furthermore, it becomes possible to design the lighting equipment having a desired light distribution characteristics easily.

Moreover, since the reflector 2 is formed with synthetic resin material, the reflective surface 21 may be deformed under the influence of heat and mechanical load, etc. by long use, for example, and there is a possibility that it may become impossible to irradiate with the light emitted from the light emitting element 5 efficiently an object. However, since the reinforcing element 23 is formed between a pair of ends 22a in the irradiation opening 22, the deforming of the reflective surface 21 can be suppressed. Accordingly, the function to irradiate with the light efficiently and correctly the object is maintainable.

Furthermore, since the shielding element 33 is arranged so that the extended line L which connects the chip portion with the light emitting element 5 may be located below from the opening end of the irradiation opening 22, the shielding element 33 hardly interrupts the effective light “A” reflected by the reflective surface 21. Moreover, unnecessary direct light which is not reflected by the reflective surface 21 in the light emitted from the light emitting element 5 is shielded by the shielding element 33. Therefore, the shielding element 33 can suppress certainly the direct light from being emitted outside as the leaked light.

Moreover, during the luminescence operation of the light emitting element 5, although the heat is generated in the light emitting element 5, the heat is conducted from the back side of the substrate 4 to the heat pipe 7 through the heat receiving element 6. The heat conducted to the heat pipe 7 is promptly transmitted to the housing 11 with a large heat dissipation area which directly acts as a heat sink by the phase change cycle of evaporation and condensation of the operating fluid. Accordingly, the heat dissipation from the housing 11 is effectively performed by the above configuration. Therefore, the suppression of the rise in heat of the light emitting element 5 is promoted.

Furthermore, the rise in temperature of the element accommodation space 18 adjoining the light source portion 12 can be suppressed by such heat transfer from the light source portion 12 and effective heat dissipation to the housing 11. Therefore, the element accommodation space 18 is efficiently securable. For example, the thermal influence to the electric power supply unit 17 or the wiring-related component accommodated in the element accommodation space 18 is reduced.

Accordingly, it becomes possible to arrange the electric power supply unit 17 near the light source portion 12, while being able to make the element accommodation space 18 small. Furthermore, miniaturization of the housing 11 can be realized, and it becomes still more possible to shorten wiring length.

In this embodiment as mentioned-above, since the heat generated in the light emitting element 5 is directly transmitted to the housing 11 by the heat pipe 7, it becomes possible to suppress the rise in temperature of the light emitting element 5 and to secure the element accommodation space 18 efficiently.

In addition, although in the above-mentioned embodiment, the electric power supply unit 17 is attached to the back side of the spacer element 13, the electric power supply unit 17 may be attached to the housing 11 side. Furthermore, the electric power supply unit 17 is not necessarily arranged in the element accommodation space 18, and may be configured using other arrangement method, for example by arranging outside the housing 11. In this embodiment, the element accommodation space 18 is mainly used for arranging the wiring-related component. The kind of the wiring-related component to be arranged is not limited specifically.

Moreover, the light source portion is not limited to the light source units described above. If solid light emitting elements are used as the light source, the form will not be limited specifically. Furthermore, the embodiments are applicable to the various lighting equipments used indoor or outdoor other than the projector.

While certain embodiments have been described, these embodiments have been presented by way of example only, and are not intended to limit the scope of the inventions. In practice, the structural elements can be modified without departing from the spirit of the invention. Various embodiments can be made by properly combining the structural elements disclosed in the embodiments. For example, some structural elements may be omitted from all the structural elements disclosed in the embodiments. Furthermore, the structural elements in different embodiments may properly be combined. The accompanying claims and their equivalents are intended to cover such forms or modifications as would fall with the scope and spirit of the inventions.

What is claimed is:

1. A lighting equipment, comprising:
a thermally conductive housing;
a light source portion accommodated in the housing and including a light emitting element as a light source;
a spacer element arranged between an inner wall of the housing and the light source portion to form an element accommodation space between the spacer element and the inner wall of the housing; and
a heat transmitting device to thermally connect the light source portion with the inner wall of the housing passing the element accommodation space.

2. The lighting equipment according to claim 1, wherein the spacer element supports the light source portion.

3. The lighting equipment according to claim 2, wherein the heat transmitting device is configured by either a heat pipe or a thermally conductive metal rod.

4. The lighting equipment according to claim 3, wherein the heat transmitting device includes a heat receiving element thermally connected with the light source portion, and the heat receiving element is also thermally connected with the inner wall of the housing through either the heat pipe or the thermally conductive metal rod.

5. The lighting equipment according to claim 4, wherein the heat pipe and the thermally conductive metal rod are thermally connected with the inner wall of the housing by fitting.

6. The lighting equipment according to claim 1, wherein the light source portion is fixed to the bottom surface of the spacer element in the shape of a box.

7. The lighting equipment according to claim 1, wherein a wiring is accommodated in the element accommodation space.

8. The lighting equipment according to claim 1, wherein the lighting equipment is formed for use of a projector.

9. The lighting equipment according to claim 1, wherein the light source portion comprises a light source unit, and the light source unit includes;
a reflector formed of synthetic resin including,
a radiation opening,
a reflective surface formed of a portion of a curved surface expanding toward the radiation opening,
a reinforcing element formed so as to connect a pair of ends of the radiation opening, and
an opening window formed in a side surface facing the reflective surface,
a light source arranged in the opening window.

10. The lighting equipment according to claim 9, wherein the light source is attached to a light source attachment substrate, further the light source attachment substrate is attached to a substrate attachment element, and the substrate attachment element is arranged in the opening window by being guided and positioned by the opening window.

11. The lighting equipment according to claim 9, wherein the light source is formed of LED.

12. A lighting equipment, comprising:
a thermally conductive housing;
a light source portion accommodated in the housing and including a light emitting element as a light source; and
a spacer element arranged between an inner wall of the housing and the light source portion to form an element accommodation space between the spacer element and the inner wall of the housing;
the light source portion includes first and second light source units; wherein,
each of the first and second light source units includes;
a reflector formed of synthetic resin having;
a radiation opening,
a reflective surface formed of a portion of a curved surface expanding toward the radiation opening,
a reinforcing element formed so as to connect a pair of ends of the radiation opening, and
an opening window formed in a side surface facing the reflective surface,
a light source attachment substrate to attach the light emitting element; and
a substrate attachment element to attach the light source attachment substrate, the substrate attachment element being guided and positioned by the opening window formed in the reflective surface; and
the first and second light source units are arranged so that the respective substrate attachment elements are arranged side-by-side and are thermally connected with the inner wall of the housing passing the element accommodation space by a heat transmitting device.

13. The lighting equipment according to claim 12, wherein the heat transmitting device is configured by either a heat pipe or a thermally conductive metal rod.

14. The lighting equipment according to claim 13, wherein the heat transmitting device includes a heat receiving element sandwiched by the pair of substrate attachment elements so that the first and second light source units are arranged side-by-side, and the heat receiving element is thermally connected with the inner wall of the housing through either the heat pipe or the thermally conductive metal rod.

15. The lighting equipment according to claim 14, wherein the heat pipe and the thermally conductive metal rod are thermally connected with the inner wall of the housing by fitting.

16. The lighting equipment according to claim 12, wherein the first and second light source units are fixed to the bottom surface of the spacer element.

17. The lighting equipment according to claim 12, wherein a wiring is accommodated in the element accommodation space.

18. The lighting equipment according to claim 12, wherein the lighting equipment is formed for use of a projector.

19. The lighting equipment according to claim 12, wherein an electric power supply unit is accommodated in the element accommodation space.

20. The lighting equipment according to claim 12, wherein the light source is formed of LED.
